(19) United States
(12) Patent Application Publication
(10) Pub. No.: US 2008/0172945 A1
(43) Pub. Date: Jul. 24, 2008

(54) Door opening assist device

(76) Inventor: Lawrence Andrew Hoffman, Portland, OR (US)

Correspondence Address: MARK S. HUBERT P.C., 516 SE MORRISON- SUITE 1200, PORTLAND, OR, 97214, US

(21) Appl. No.: 11/657,434

(22) Filed: Jan. 23, 2007

(51) Int. Cl. E05F 1/10; E06B 3/32

(52) U.S. Cl. 49/386; 296/202

(57) ABSTRACT

The present invention provides a door opening assist device comprising a compression spring and piston retainably housed in a bind ended longitudinal bore formed in an externally threaded cylindrical housing. The spring and piston are held in cooperative engagement between a retaining nut and the blind end. The piston has a single protuberance extending normally from it's surface that resides in and travels about a spiral groove formed in the housing. The spiral groove has a series of detents, one of which can be selected to trap the protuberance and stop the spinning piston as it travels along the housing bore.

The door opening assist device is installed in a door frame of an automobile to push the door open a distance determined by the detent selected. Upon closing the door, the door abuts and retracts the piston into the housing compressing the spring. Upon unlatching the door, the piston extends under spring bias in such a direction and with sufficient force to push the door to an open position a predetermined distance. The door opening assist device provides various mounting options through the use of a jam nut and a mounting plate.

### BACKGROUND OF THE INVENTION

The present invention relates to automobile doors, and more particularly, to mechanical door opening assist devices for use on automobile doors, hoods and trunks.

With many automobile owners not satisfied with the style, quality, and availability of the features provided by the automakers, owners have turned to aftermarket component manufacturers and even automobile kit manufacturers for satisfaction. The owners of hot rod, street rod, and classic automobiles are always looking for ways to customize and differentiate their cars from others, and styling, shape and form are high on the list of attributes that these owners wish to improve. The automobile customizing industry continuously strives to provide new and exciting features for the such consumers.

A growing trend for customizers is to present their automobiles with a sleek, sculpted body. Body trim components and other embellishments are giving way to smooth body panels, hoods and grills. One component of the automobile that intrudes on the sleek look of the side body panels is the door handle.

The aftermarket component manufacturers are providing the automobile owner with an ever-increasing selection of components to add to, replace, or modify the standard automobile features. A popular aftermarket component is what is known as a shaved door handle system. The shaved door handle system allows for the complete removal of exterior door handles providing a continuous smooth appearance across the side body panels. Without an exterior door handle, the shaved door handle system provides a remotely controlled, electrically powered door lock and latch actuator. Once the door is unlocked and unlatched, there is still a need to open the door as there is no handle to pull the door open. An internal door opening assist device is needed to push open the door to allow entry.

Door opening assist devices come in a variety of forms. Electrically operated solenoids and linear actuators have been used with some success. These systems, though, require electrical power to operate and rather complex timing logic to control activation with respect to the unlock and unlatch mechanisms.

The present invention is a spring-biased piston that is mounted in the door frame. When the door is closed, the piston is pushed against a spring by a door surface which compresses the spring. The door latch holds the door in a closed position against the potential energy of the spring-loaded piston. Upon the unlatching of the door, the spring-biased piston extends, spinning in its housing until it reaches an adjustable stop, pushing against the door surface and opening the door. This solution provides a door opening device that requires no power to operate, and requires no timing logic to activate. The spring is not exposed, eliminating as safety hazard as well as increasing the reliability hazard by eliminating dirt and debris infiltration.

Current spring-biased piston devices do not have provisions to adjust the tension and throw of the piston. It is desirable for the user to be able to adjust the throw of the door to account for the weight and balance of the door as well as personal preference. Additionally, many of the current devices require a substantial amount of door cavity space to de dedicated to it's installation. Not all vehicles have such excess space. Accordingly, there is a need for a door opener assist device that is simple in operation, requires no electrical power, is easily installed by the consumer, and has easily adjustable door opening characteristics. Henceforth, a mechanical door opening device having a shorter operating profile and an adjustable stroke would fulfill a long felt need in the automobile customizing industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a door opening assist device that is able to be installed with a minimum of spacial intrusion to the door cavity, and allows for an adjustable amount of opening thrust.

It has many of the advantages mentioned heretofore and many novel features that result in a new door opening assist device which is not anticipated, rendered obvious, suggested, or even implied by any of the prior art, either alone or in any combination thereof.

In accordance with the invention, an object of the present invention is to provide an improved door opening assist device capable of allowing the end user the capability of easily adjusting the thrust.

It is another object of this invention to provide an improved door opening assist device capable of allowing the end user ease of installation as well as numerous aesthetic installation options.

It is a further object of this invention to provide an improved door opening assist device that is economical to fabricate and essentially mechanically infallible.

It is still a further object of this invention to provide for an improved door opening assist device that is minimally intrusive with respect to the internal door cavity.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is an exploded view of the preferred embodiment door opening assist device without the inner and outer mounting nuts;

FIG. 2 is an exploded cross sectional side view of the preferred embodiment door opening assist device;

FIG. 3 is a front view of a mounting plate;

FIG. 4 is a cross sectional side view of the assembled preferred embodiment door opening assist device installed in a vehicle door with the piston extended;

FIG. 5 is a cross sectional side view of the preferred embodiment door opening assist device installed in a vehicle door with the piston compressed;

FIG. 6 is a is a cross sectional side view of the preferred embodiment door opening assist device with a mounting plate installed in a vehicle door;

FIG. 7 is a cross sectional side view of the preferred embodiment door opening assist device with a mounting plate installed in a vehicle door;

FIG. 8 is an end view of a door opening assist device installed in a vehicle door; and

FIG. 9 is an exploded view of the alternate embodiment door opening assist device without the outer mounting nut.

### DETAILED DESCRIPTION

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

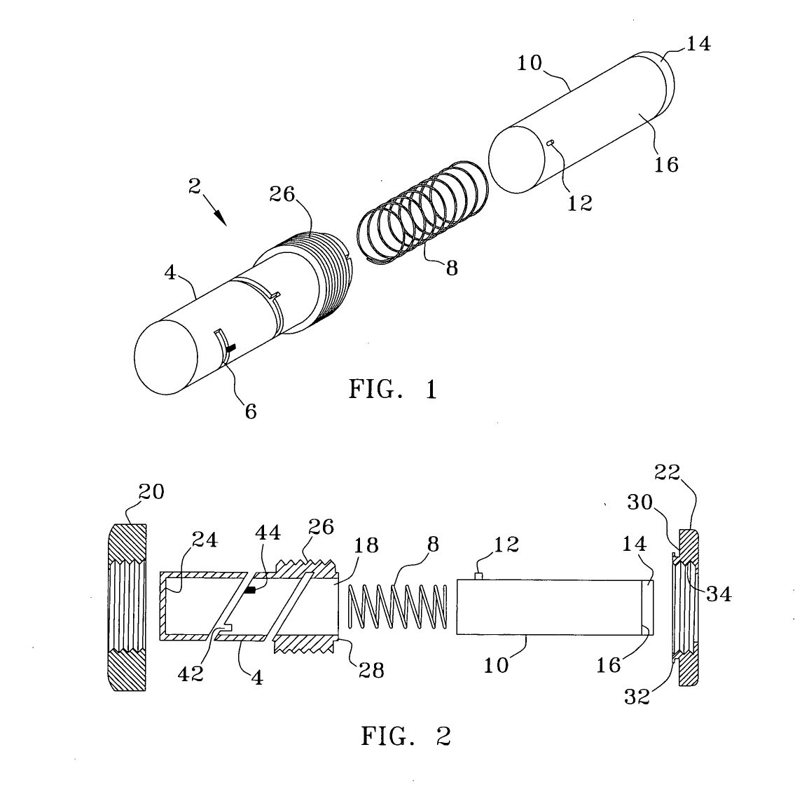

Looking at FIGS. 1, 2 and 3, it can be seen that the preferred embodiment door opening assist device 2 comprises a compression spring 8, a cylindrical housing 4, a cylindrical piston 10, an inner mounting nut 20, an outer mounting nut 22, and a mounting plate 38. The cylindrical housing 4 has a blind or stopped bore 18 formed therein about the longitudinal axis of the housing and terminating at a second end 24 of the housing 4. The housing bore 18 is sized to slidingly receive the piston 10. A spiral groove 6 is formed thereon the housing 4 about the housing's longitudinal axis. The groove 6 has a series of detents 42 projecting therefrom. Removable tabs 44 reside within each detent 42 so as to occupy the space of the detent 42 unless removed. An external thread 26 is formed at the first end 28 of the housing 4 and extends partially along the length of the housing 4. The piston 10 has a protuberance 12 that resides normally from the outer surface of the piston 10 and is appropriately sized to freely slide within the spiral groove 6 or within any unblocked detent 42. A resilient tip 14 is affixed to a first end 16 of the piston 10.

The outer mounting nut 22 has a recessed retention ring 30 adjacent a raised profile capture ring 32 formed at a proximate end thereof. The internal threads 34 do not extend the entire thickness of the outer mounting nut 22 such that the distal end of the outer mounting nut 22 may have a smaller internal diameter than that of the proximate end. This reduced diameter may serve to abut the protuberance 12 and restrict the passage of the piston 10 completely from the housing 4.

The mounting plate 38 is a generally planar metal plate that has a central orifice 36 formed therein and two mounting apertures 40. The mounting apertures 40 are adapted to accept conventional mounting fasteners. Examples of acceptable fasteners 46 include, but are not limited to, rivets, sheet metal screws, self-tapping screws, bolts and nuts.

The capture ring 32 has a sloping surface and an external diameter that is greater than the internal diameter of the central orifice 36 of the mounting plate 38. The retention ring 30 has an external diameter slightly smaller than the internal diameter of the mounting plate central orifice 36. The mounting plate 38 is adapted to be forcefully advanced over the capture ring 32 to seat into the retention ring 30. This action locks the mounting plate 38 in a position normal to the longitudinal axis of the housing 4.

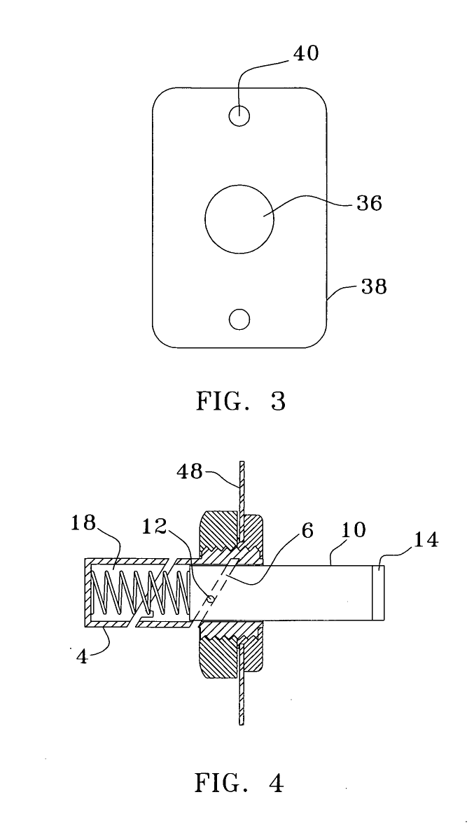

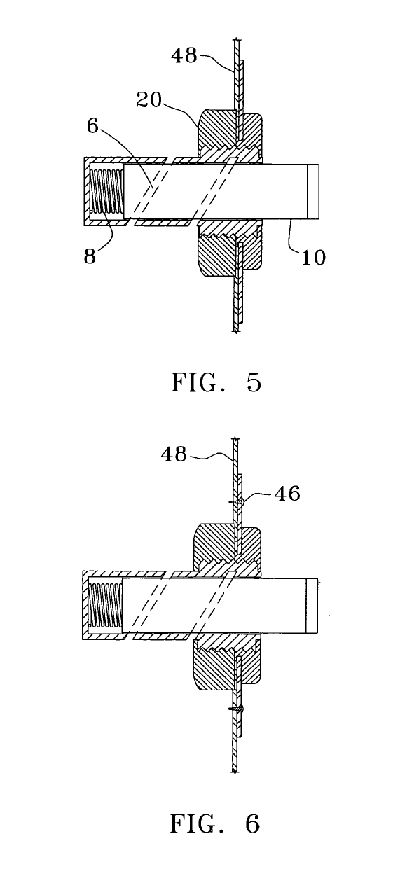

Looking At FIGS. 4 and 5, cross sectional side views of the assembled preferred embodiment door opening assist device with the piston extended and compressed, the operation of the device 2 can best be explained. In one typical application directed toward automobiles, the door opening assist device 2 is installed in a door frame 48 of an automobile with the express purpose to push the door open a predetermined distance upon the release of the car door closure latch. An orifice is drilled in the automobile's door jam or pillar and the door's inner panel is removed. The diameter of this orifice is slightly larger than the outside diameter of the threaded region 26 of the housing 4. The inner mounting nut 20 and the outer mounting nut 22 are then threadingly engaged with the housing threads 26 so as to each abut and jointly sandwich the pillar's sheet metal between themselves.

Upon closing the door, the door abuts the resilient tip 14 of piston 10. The continued force of the inward closing door exerts pressure onto the extended piston 10 which causes the spring 8 to compress, (FIG. 4) and piston 10 to spiral within bore 18 as directed and guided by protuberance 12 as it travels within spiral groove 6 until the door reaches its final position and a door closure latch restrains the door. Once the door is locked shut the spring 8 is compressed. (FIG. 5)

Upon unlatching the door, the piston 10, guided by the movement of the protuberance 12 within the spiral groove 6, spins while traversing out of the housing bore 18 as the spring uncompresses. The piston 10 extends under spring bias in such a direction and with sufficient force to push the door to an open position a predetermined distance. This distance is determined by the abutment of the protuberance 12 with the outer mounting nut 22 or a housing detent 42 if any detents have the tab 44 removed. The detent 42 chosen to have it's tab 44 removed will capture the passing protuberance 12 and thus determine the stroke of the piston 10. The piston 10 will impart enough kinetic energy that the inertia of the door will carry the door open to a predetermined distance after contact between the piston 10 and the door is broken. The adjustment feature is used to tailor the opening characteristics of the door opening assist device 2.

The helical spring 8 is formed from stiff wire appropriate for the particular purpose. The length and diameter of the spring wire is selected for the weight and opening resistance of the door. By specific selection of the spring, the distance a door is sprung open may be adjusted. Replacement/change of the spring 8 is easily accomplished by the removal of the outer mounting nut 22, the slight depression of the piston 8 so as to ensure the protuberance 12 is not in a detent 42, and the simultaneous rotation and extraction of piston 10 from within bore 18. The spring 8 can then be removed from within the housing 4. Installation of a new spring 8 follows the reverse procedure.

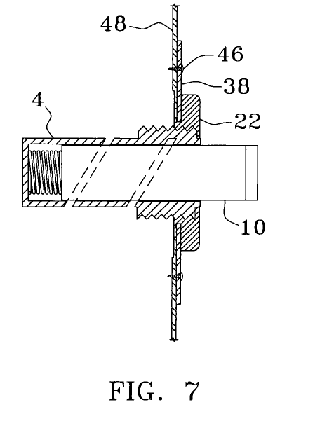

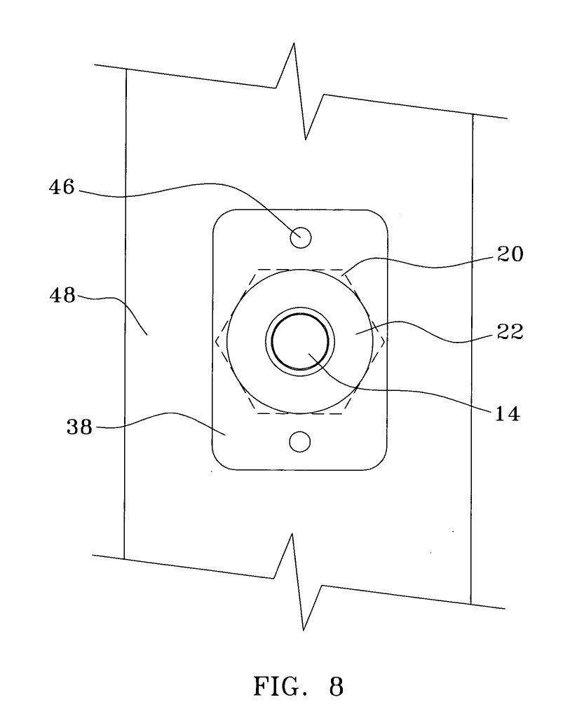

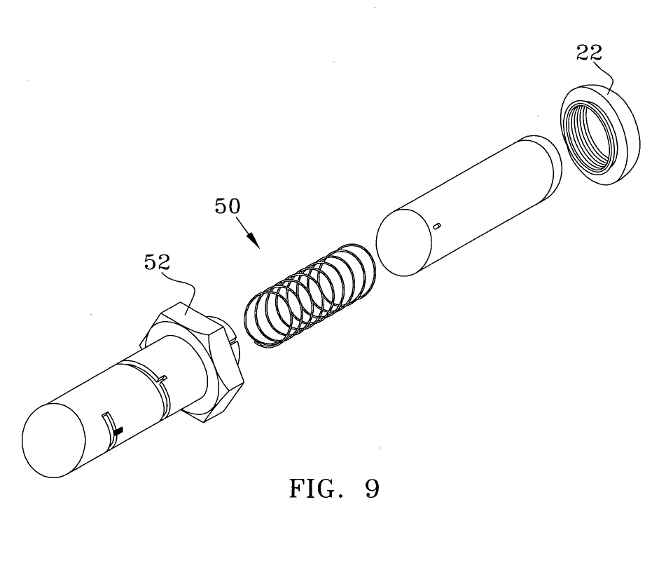

An optional mounting method for the device is provided by the mounting plate 38. When the mounting plate 38 is forcefully advanced over the capture ring 32 so as to seat into the retention ring 30, it may be mechanically affixed to the door with fasteners 46 as well as the inner mounting nut 20 and outer mounting nut 22. Examples of acceptable fasteners 46 include, but are not limited to, rivets, sheet metal screws, self-tapping screws, bolts and nuts. This additional mounting element will stabilize and increase the rigidity of the device 2 in the door pillar. When the mounting plate 38 is utilized, the device 2 may be installed with the inner mounting nut 20 or without it, as depicted in FIG. 7. This may be preferable in certain installations as it does not require the door panel to be removed for installation. FIG. 8 illustrates the installed door opening assist device 2 with mounting plate 38 as viewed from the front. The mounting plate 38 may be recessed flush to the door pillar 46 or mounted against and raised from the surface of the pillar 48.

In the alternate embodiment door opening assist device 50 of FIG. 7, there is no inner mounting nut but rather an inner mounting flange 52 that is formed adjacent to the threads 26 on the first end 28 end of the housing 4. It is positionally maintained in the door pillar by the abutment of the outer mounting nut 22 and the inner mounting flange 52 against opposing sides of the pillar's sheet metal. The installation of this alternate embodiment may optionally use the mounting plate 38 and fasteners 46.

The tip 14 is made of a resilient material, such as but not limited to, plastic and rubber. The tip 14 provides protection for the area of the door that is contacted by the piston 10. The attachment of the tip 14 is made with well known methods including, but not limited to, adhesive end fasteners. As is well known in the art, a blind recess may be provided in the first end of the piston 10 for a matingly conformed tip. The resilient tip 14 is useful for, but not limited to, reducing the need for a strike plate, to protected the finish of the contact area and to reduce any contact noise between the contact area and the piston 10.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

Although the above described invention is focused on use with a car door, it is equally applicable and can easily be adapted for a plethora of other openable structures such as, but not limited to, doors, hoods, trunks.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

Having thus described the invention, what is claimed as new and desired to be secured by Letters Patent is as follows:

1. A door opening assist device, comprising:
a cylindrical piston having a protuberance residing normally on an outer surface thereof;
a compression spring;
a cylindrical housing having an externally threaded first end, a longitudinal blind bore extending a portion of the length of said housing and terminating at a second end, and a spiral groove formed therein;
an outer mounting nut; and
an inner mounting nut;
wherein said spring and said piston are slidingly mounted therein said housing such that the spring urges the piston to extend a distance from the first end of the housing, and wherein said piston protuberance resides in cooperative engagement within said spiral groove, the piston adjustably extending from the first end of the housing a distance limited by the travel of said protuberance, and wherein the second end of the door opening assist device is adapted to pass through an aperture formed in a structure, the inner mounting nut and outer mounting nut engaging the threads to constrain the structure between the inner and outer mounting nuts.

2. The door opening assist device of claim 1, wherein said spiral groove has at least one detent formed therein, said detent sized to capture and receive said protuberance so as to retain said piston at a predetermined amount beyond said first end.

3. The door opening assist device of claim 2, further comprising a removable tab housed in said detent.

4. The door opening assist device of claim 3 wherein said compression spring is a helical wound spring.

5. The door opening assist device of claim 4, further comprising a resilient tip coupled to the piston at an end external to the housing.

6. The door opening assist device of claim 5, wherein the housing, piston, inner mounting nut and outer mounting nut are made from metal.

7. A door opening assist device, comprising:
a cylindrical piston having a protuberance residing normally on an outer surface thereof;
a compression spring;
a mounting nut;
a cylindrical housing having a flange formed thereon and external threads extending at least a portion of the length of the housing proximate the flange and a first end of said housing, a longitudinal blind bore extending a portion of the length of said housing and terminating at a second end of said housing, and a spiral groove formed therein;
wherein said spring and said piston are slidingly mounted therein said housing such that the spring urges the piston to extend a distance from the first end of the housing, and wherein said piston protuberance resides in cooperative engagement within said spiral groove, the piston adjustably extending from the first end of the housing a distance limited by the travel of said protuberance, wherein said first end of the door opening assist device is adapted to pass through an aperture in a structure, the mounting nut engaging the threads to constrain the structure between the flange and the mounting nut.

8. The door opening assist device of claim 7, wherein said spiral groove has at least one detent formed therein, said detent sized to capture and receive said protuberance so as to retain said piston at a predetermined amount beyond said first end.

9. The door opening assist device of claim 8, further comprising a removable tab housed in said detent.

10. The door opening assist device of claim 9 wherein said compression spring is a helical wound spring.

11. The door opening assist device of claim 10, further comprising: a resilient tip coupled to the piston at an end external to the housing.

12. The door opening assist device of claim 11, wherein the housing, piston, and mounting nut are made from one material component.

13. The door opening assist device of claim 12, wherein the one material component is an aluminum billet.

14. A door opening assist device, comprising:
a cylindrical piston having a protuberance residing normally on an outer surface thereof;
a compression spring;
a cylindrical housing having an externally threaded first end, a longitudinal blind bore extending a portion of the length of said housing and terminating at a second end, and a spiral groove formed therein;
a mounting plate having at a mounting aperture and least one structure attachment aperture formed therein;
an inner mounting nut; and
an outer mounting nut with a recessed retention ring having a diameter smaller than the mounting aperture formed thereon, adjacent a raised profile capture ring formed thereon, said capture ring having a sloping surface and a diameter that is greater than a diameter of the mounting aperture of, wherein the mounting plate is adapted to be forcefully advanced over the capture ring to seat into the retention ring;
wherein said spring and said piston are slidingly mounted therein said housing such that the spring urges the piston to extend a distance from the first end of the housing, and wherein said piston protuberance resides in cooperative engagement within said spiral groove, the piston adjustably extending from the first end of the housing a distance limited by the travel of said protuberance, and wherein the second end of the door opening assist device is adapted to pass through an aperture formed in a structure, the inner mounting nut and outer mounting nut engaging the threads to constrain the structure between the inner and outer mounting nuts.

15. The door opening assist device of claim 14, wherein said spiral groove has at least one detent formed therein, said detent sized to capture and receive said protuberance so as to retain said piston at a predetermined amount beyond said first end.

16. The door opening assist device of claim 15, further comprising a removable tab housed in said detent.

17. The door opening assist device of claim 16 wherein said compression spring is a helical wound spring.

18. The door opening assist device of claim 17, further comprising a resilient tip coupled to the piston at an end external to the housing.

19. The door opening assist device of claim 18, wherein the housing, piston, inner mounting nut and outer mounting nut are made from metal.
